(19) United States
(12) Patent Application Publication
(10) Pub. No.: US 2026/0200367 A1
(43) Pub. Date: Jul. 16, 2026

(54) VEHICLE PROPULSION SYSTEM WARMUP USING DYNAMIC TORQUE MODULATION

(71) Applicant: GM GLOBAL TECHNOLOGY OPERATIONS LLC, DETROIT, MI (US)

(72) Inventors: Ye Cheng, Troy, MI (US); Norman K. Bucknor, Troy, MI (US); Renato Amorim Torres, Pontiac, MI (US); Neeraj S. Shidore, Novi, MI (US); Suresh Gopalakrishnan, Troy, MI (US); Vinod Chowdary Peddi, Shelby Township, MI (US); Madhusudan Raghavan, West Bloomfield, MI (US)

(21) Appl. No.: 19/016,226

(22) Filed: Jan. 10, 2025

(51) Int. Cl. B60L 58/27

(52) U.S. Cl. CPC B60L 58/27; B60L 2240/423; B60L 2240/545

(57) ABSTRACT

A method includes detecting an occurrence of a trigger event associated with a battery system of a vehicle. The method further includes, responsive to detecting the occurrence of the trigger event, dynamically modulating an electric motor torque command between a first torque value and a second torque value that is less than the first torque value. The electric motor torque command causes an electric motor of the vehicle to provide torque at a value defined by the electric motor torque command. The method further includes monitoring a temperature of the battery system while dynamically modulating the electric motor torque command. The method further includes, responsive to determining that the temperature of the battery system satisfies a temperature threshold, ceasing dynamically modulating the electric motor torque command.

### BACKGROUND

The subject disclosure relates to vehicles, and in particular to vehicle propulsion system warmup using dynamic torque modulation.

Electric vehicles (EV) and hybrid electric vehicles (HEV) (i.e., electrified vehicles) may include a propulsion system including one or more electric drive units having an electric traction motor and a rechargeable energy storage system (RESS), which may include one or more batteries, connected to the one or more electric drive units. The one or more electric drive units provide propulsive force to wheels of the vehicle to cause the vehicle to move. Popular motor control methodologies include field-oriented control and direct torque control. Motor control provides for controlling, among other things, an amount of torque applied by the one or more electric drive units of the vehicle. Various factors contribute to the range of an EV or HEV, such as battery capacity, weight, and drive system efficiency.

In certain scenarios, it is desirable to warm up the RESS of an EV or HEV for efficient operation of the vehicle.

### SUMMARY

In one embodiment, a computer-implemented method is provided. The method includes detecting an occurrence of a trigger event associated with a battery system of a vehicle. The method further includes, responsive to detecting the occurrence of the trigger event, dynamically modulating an electric motor torque command between a first torque value and a second torque value that is less than the first torque value. The electric motor torque command causes an electric motor of the vehicle to provide torque at a value defined by the electric motor torque command. The method further includes monitoring a temperature of the battery system while dynamically modulating the electric motor torque command. The method further includes, responsive to determining that the temperature of the battery system satisfies a temperature threshold, ceasing dynamically modulating the electric motor torque command.

In addition to one or more of the features described herein, or as an alternative, further embodiments of the method may include that the trigger event is a user command.

In addition to one or more of the features described herein, or as an alternative, further embodiments of the method may include that the trigger event is the temperature of the battery system being below the temperature threshold.

In addition to one or more of the features described herein, or as an alternative, further embodiments of the method may include that the battery system is a rechargeable energy storage system (RESS).

In addition to one or more of the features described herein, or as an alternative, further embodiments of the method may include that the vehicle is selected from a group consisting of an electric vehicle, a hybrid electric vehicle, and a plug-in hybrid electric vehicle.

In addition to one or more of the features described herein, or as an alternative, further embodiments of the method may include that the first torque value and the second torque value are selected to maximize battery system heat generation.

In addition to one or more of the features described herein, or as an alternative, further embodiments of the method may include that the first torque value is an amount of torque greater than a maximum efficiency torque value for the electric motor.

In addition to one or more of the features described herein, or as an alternative, further embodiments of the method may include randomly selecting a wave shape of the electric motor torque command, a frequency of the electric motor torque command, and a peak amplitude of the electric motor torque command.

In addition to one or more of the features described herein, or as an alternative, further embodiments of the method may include ceasing dynamically modulating the electric motor torque command responsive to determining that the electric motor is operating in a restricted zone.

In another embodiment, a vehicle is provided. The vehicle includes an electric motor, a battery system electrically coupled to the electric motor, and a processing system. The processing system includes a memory having computer readable instructions and a processing device for executing the computer readable instructions, the computer readable instructions controlling the processing system to perform operations. The operations include detecting an occurrence of a trigger event associated with the battery system of the vehicle. The operations further include, responsive to detecting the occurrence of the trigger event, dynamically modulating an electric motor torque command between a first torque value and a second torque value that is less than the first torque value. The electric motor torque command causes the electric motor of the vehicle to provide torque at a value defined by the electric motor torque command. The operations further include monitoring a temperature of the battery system while dynamically modulating the electric motor torque command. The operations further include, responsive to determining that the temperature of the battery system satisfies a temperature threshold, ceasing dynamically modulating the electric motor torque command.

In addition to one or more of the features described herein, or as an alternative, further embodiments of the vehicle may include that the trigger event is a user command.

In addition to one or more of the features described herein, or as an alternative, further embodiments of the vehicle may include that the trigger event is the temperature of the battery system being below the temperature threshold.

In addition to one or more of the features described herein, or as an alternative, further embodiments of the vehicle may include that the battery system is a rechargeable energy storage system (RESS).

In addition to one or more of the features described herein, or as an alternative, further embodiments of the vehicle may include that the vehicle is selected from a group consisting of an electric vehicle, a hybrid electric vehicle, and a plug-in hybrid electric vehicle.

In addition to one or more of the features described herein, or as an alternative, further embodiments of the vehicle may include that the first torque value and the second torque value are selected to maximize battery system heat generation.

In addition to one or more of the features described herein, or as an alternative, further embodiments of the vehicle may include that the first torque value is an amount of torque greater than a maximum efficiency torque value for the electric motor.

In addition to one or more of the features described herein, or as an alternative, further embodiments of the vehicle may include that the operations further include randomly selecting a wave shape of the electric motor torque command, a frequency of the electric motor torque command, and a peak amplitude of the electric motor torque command.

In addition to one or more of the features described herein, or as an alternative, further embodiments of the vehicle may include that the operations further include ceasing dynamically modulating the electric motor torque command responsive to determining that the electric motor is operating in a restricted zone.

In another embodiment a computer program product is provided. The computer program product includes a set of one or more computer-readable storage media and program instructions, collectively stored in the set of one or more storage media, for causing a processor set to perform computer operations. The operations include detecting an occurrence of a trigger event associated with a battery system of a vehicle. The operations further include, responsive to detecting the occurrence of the trigger event, dynamically modulating an electric motor torque command between a first torque value and a second torque value that is less than the first torque value. The electric motor torque command causes an electric motor of the vehicle to provide torque at a value defined by the electric motor torque command. The operations further include monitoring a temperature of the battery system while dynamically modulating the electric motor torque command. The operations further include, responsive to determining that the temperature of the battery system satisfies a temperature threshold, ceasing dynamically modulating the electric motor torque command.

In addition to one or more of the features described herein, or as an alternative, further embodiments of the computer program product may include that the trigger event is the temperature of the battery system being below the temperature threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a computer system for vehicle propulsion system warmup using dynamic torque modulation according to one or more embodiments;

FIG. 2 illustrates the computer system of FIG. 1 for vehicle propulsion system warmup using dynamic torque modulation according to one or more embodiments;

FIGS. 3A, 3B, 3C, and 3D illustrate graphs for vehicle propulsion system warmup using dynamic torque modulation according to one or more embodiments; and

FIG. 4 illustrates a flow diagram of a method for vehicle propulsion system warmup using dynamic torque modulation according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to vehicle propulsion system warmup using dynamic torque modulation.

Electric vehicles (EV) and hybrid electric vehicles (HEV) (including plug-in hybrid electric vehicles (PHEV)) utilize a propulsion system that includes one or more electric drive units (e.g., electric motors) and a battery system, such as a rechargeable energy storage system (RESS). The battery system, typically including one or more batteries, provides the necessary power to the electric drive units (e.g., electric motors), which in turn generate the torque used to propel the vehicle.

Efficient operation of the battery system improves vehicle performance. However, in some situations, such as cold ambient conditions, performance of the battery system can be significantly impaired. For example, cold temperatures can reduce the battery system's ability to efficiently deliver power and accept charge, leading to decreased vehicle range and performance. As one non-limiting example, at −7 degrees Celsius, RESS peak power can be reduced by substantially 33%.

Existing approaches for warming up the battery system in EVs and HEVs often involve preconditioning strategies that use external power sources or resistive heating elements to increase the battery temperature. These approaches can be inefficient, time-consuming, and may not be practical, especially when the vehicle is in use. Additionally, traditional motor control strategies, such as field-oriented control and direct torque control, do not adequately address the need for rapid battery warmup during driving conditions. These strategies focus primarily on optimizing motor efficiency and torque delivery, without considering the thermal management of the battery system. One such approach uses dynamic torque modulation (DTM) to control the motor such that motor operating efficiency is improved for operating points below a best-operating efficiency line (for constant voltage and temperature).

One or more embodiments described address these and other shortcomings by employing dynamic torque modulation (DTM) to generate heat within the battery system during driving conditions. For example, such embodiments extend the idea of using DTM by allowing torque points above the best-operating efficiency line to maximize the DTM torque amplitude, subject to motor operational constraints (e.g., torque slew rate). By maximizing the torque, the battery current I used to generate that torque can be increased relative to the nominal non-DTM motor torque, thereby increasing the irreversible heat generation in the battery, defined by I×I×resistance. This also has the effect of increasing motor heat generation since the motor is operating at an efficiency worse than would be utilized at the best-efficiency point under nominal DTM operations. The frequency of DTM operation under the battery heating scenario is also different than under nominal operating conditions since the frequency should be high enough to avoid damaging the battery. By dynamically modulating the electric motor torque command, one or more embodiments increases battery heat generation, thereby warming up the battery system more quickly than existing motor control strategies. One or more embodiments enhances the battery system's performance in cold ambient conditions and improves the overall efficiency of the vehicle's propulsion system. The DTM strategy can be applied to various motor technologies and configurations, making the strategy a versatile solution for different types of EVs and HEVs.

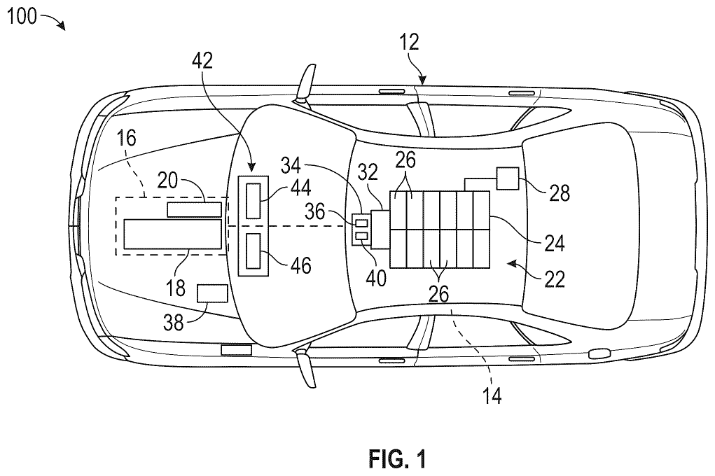

FIG. 1 shows an embodiment of a vehicle 100, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 100 may be an electric vehicle (EV), a hybrid electric vehicle (HEV), plug-in hybrid electric vehicle (PHEV), and/or the like, including combinations and/or multiples thereof. In an embodiment, the vehicle 100 is a HEV that includes a combustion engine assembly 18 and at least one electric motor assembly. In this embodiment, the propulsion system 16 includes an electric motor 20, and may include one or more additional motors positioned at various locations. The electric motor 20 can be any suitable motor technology, with or without permanent magnets, and single-phase or multi-phase. For example, the electric motor 20 can be a permanent magnet motor (with rare earth magnets, without rare earth magnets, with reduced rare earth magnets, with ferrite magnets, with iron nitride, etc.), an induction motor, a separately excited motor, a reluctance-type motor, and/or the like, including combinations and/or multiples thereof. With dual winding multi-phase motors, either set of windings or both can be used for dynamic torque modulation.

The vehicle 100 includes a battery system 22, which may be electrically connected to the electric motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26. The battery system 22 may also include a monitoring unit 28 that includes components, such as a processor, memory, an interface, a bus and/or other suitable components.

The battery system 22 is electrically connected to components of the propulsion system 16. According to one or more embodiments, the propulsion system includes a direct current (DC)-DC converter module 32 and an inverter module 34. The inverter module 34 (e.g., a traction power inverter module (TPIM)) converts DC power from the battery system 22 to poly-phase alternating current (AC) power (e.g., three-phase, six-phase, etc.) to drive the electric motor 20. In an embodiment, the inverter module 34 includes an inverter 36 connected to the DC-DC converter module 32 for receiving DC power and is connected to the electric motor 20 for providing poly-phase AC power thereto.

The propulsion system 16 includes or is connected to a vehicle controller 38 that controls aspects of the vehicle and a motor controller 40 that provides electric motor torque commands to the electric motor 20. The motor controller 40 may be part of the inverter module 34 or may be a separate module or unit.

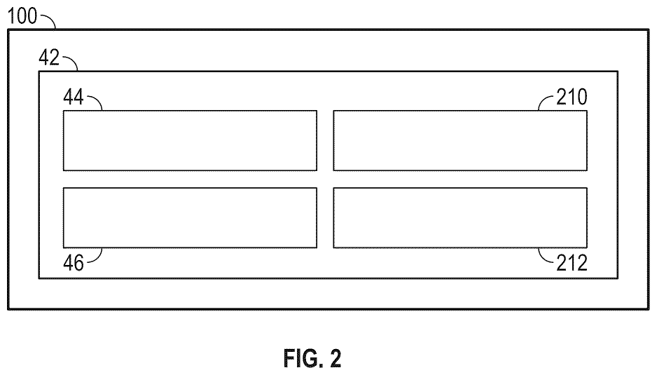

The vehicle 100 also includes a computer system 42 that includes one or more processing devices 44 and a memory 46. The one or more processing devices 44 and the memory 46 may communicate with one another via a communication bus, such as a controller area network (CAN) or transmission control protocol (TCP) bus. According to one or more embodiments, the vehicle controller 38 and/or the motor controller 40 can be implemented as instructions executable by the computer system 42 or another suitable system or device. Features and functionality of the computer system 42 and/or certain aspects of the vehicle 100 are now described with reference to FIG. 2. It is understood that one or more embodiments described herein is capable of being implemented in conjunction with any other type of computer system, device, or environment now known or later developed.

Particularly, FIG. 2 illustrates the computer system 42 of FIG. 1 according to one or more embodiments. According to one or more embodiments, the computer system 42 includes the one or more processing devices 44, the memory 46, a motor controller engine 210, and a dynamic torque modulation (DTM) engine 212. It should be appreciated that the computer system 42 can be any device suitable for performing or supporting infrastructure access control using vehicle-based lidar. For example, the computer system 42 can be a device implemented in or otherwise associated with the vehicle 100, such as an electronic control unit (also referred to as an electronic control module). As another example, the computer system 42 can be a smartphone, tablet computer, laptop computer, desktop computer, wearable computing device, and/or the like, including combinations and/or multiples thereof.

The one or more processing devices 44 is responsible for executing instructions and managing the overall operation of the computer system 42. The one or more processing devices 44 can be any suitable processing circuitry for executing instructions and processing data. For example, the one or more processing devices 44 can be a microcontroller, microprocessor, application-specific integrated circuit (ASIC), or any other type of processing unit capable of handling the computational demands of the computer system 42.

The memory 46 stores data, computer-readable instructions, and/or algorithms useful for operation of the computer system 42 and/or the vehicle 100. This may include real-time data processing, historical data analysis, and storage of firmware or software programs. The memory 46 is any suitable device for storing data and/or instructions. For example, the memory 46 can be a combination of volatile memory (e.g., random access memory) and non-volatile memory (e.g., read-only memory, flash memory).

The motor controller engine 210 is responsible for generating and that provides electric motor torque commands to the electric motor 20. The electric motor torque commands instruct the electric motor 20 regarding how much torque to generate, and the electric motor 20 generates the amount of torque defined by the electric motor torque command.

The dynamic torque modulation engine 212 dynamically modulates the electric motor torque command between a first torque value and a second torque value that is less than the first torque value.

According to one or more embodiments, the motor controller engine 210 and/or the dynamic torque modulation engine 212 are implemented as computer-readable instructions stored in the memory 46, which are executable by the one or more processing devices 44 to perform one or more of the functions described herein.

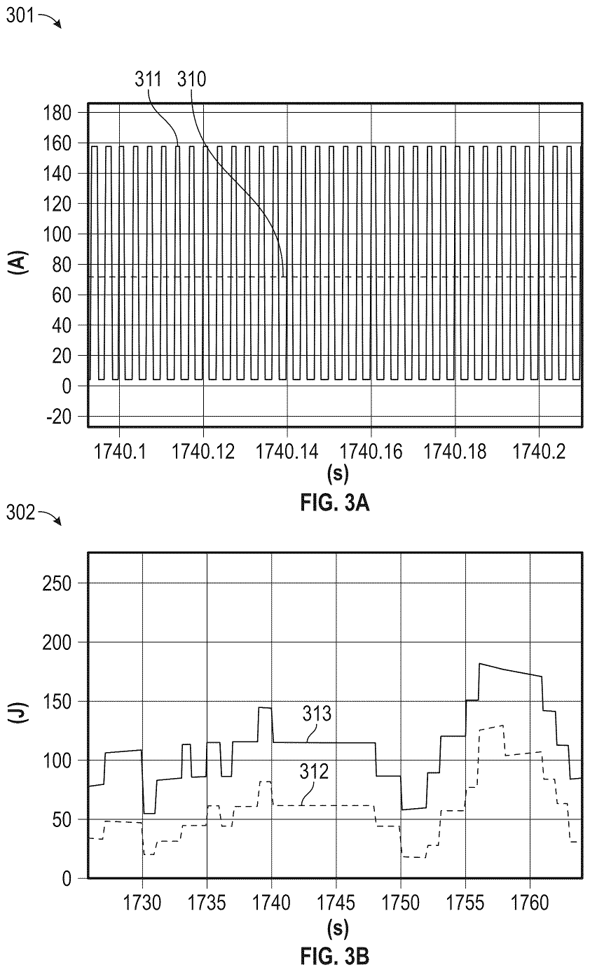

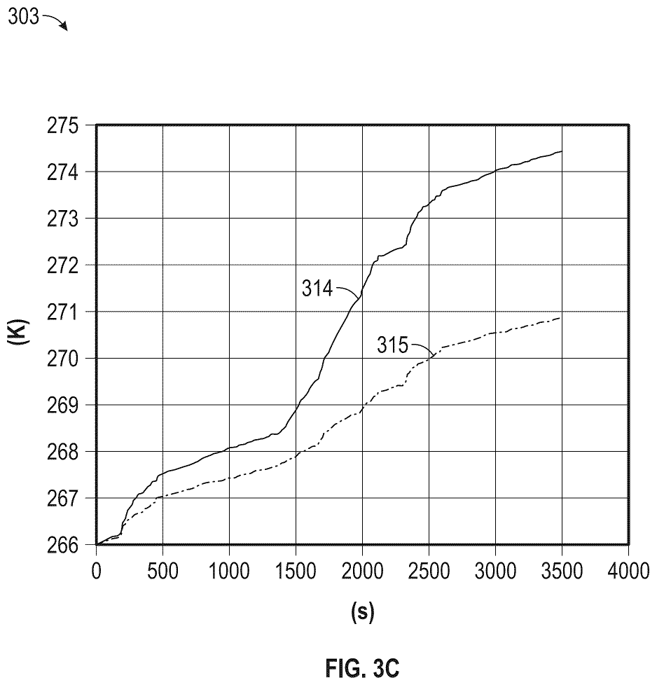

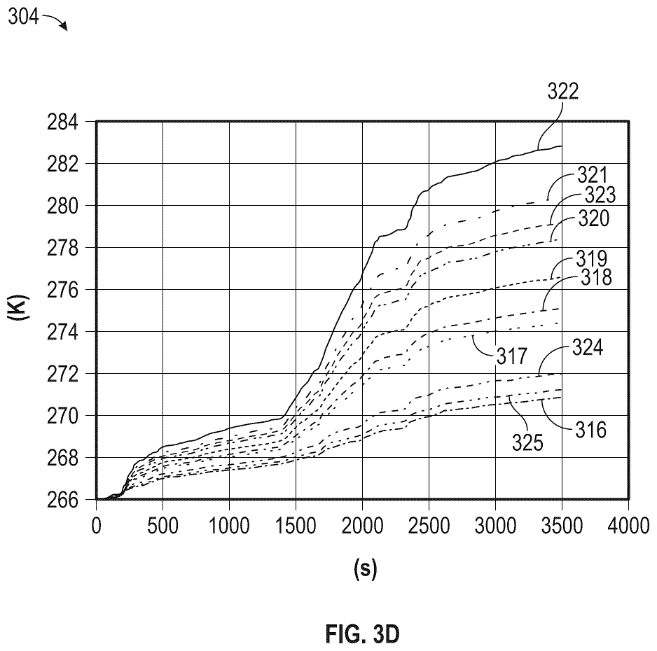

FIGS. 3A, 3B, 3C, and 3D illustrate graphs 301, 302, 303, 304 for vehicle propulsion system warmup using dynamic torque modulation according to one or more embodiments. The graphs 301-304 provide various visual representations of the battery current (graph 301), battery heat generation (graphs 302, 303), and battery temperature (graph 304) under different conditions, specifically comparing scenarios with and without DTM.

Graph 301 shows the battery current of the battery system 22 during a cold-temperature City-Highway-City (CHC) test. The x-axis represents time in seconds, while the y-axis represents battery current of the battery system 22 in amperes (A). Line 310 represents the battery current without DTM being implemented, and line 311 represents the battery current with DTM. The graph demonstrates how DTM affects the battery current over time.

Graph 302 illustrates the battery heat generation during the same CHC test of graph 301. The x-axis represents time in seconds, and the y-axis represents irreversible battery heat generation in joules (J). Line 312 represents the battery heat generation without DTM, and line 313 represents the battery heat generation with DTM. This graph shows that DTM increases the heat generation within the battery system 22 as compared to not applying DTM.

Graph 303 depicts the battery temperature during the same CHC of graphs 301 and 302. The x-axis represents time in seconds, and the y-axis represents battery temperature in degrees Kelvin (° K). Line 314 represents the battery temperature with DTM, and line 315 represents the battery temperature without DTM. This graph indicates that DTM results in a faster and higher increase in battery temperature compared to scenarios without DTM.

Graph 304 shows the battery temperature during the CHC test under various DTM conditions. The x-axis represents time in seconds, and the y-axis represents battery temperature in degrees Kelvin (° K). The graph 304 includes multiple lines (316 to 325) representing different DTM configurations, such as varying the peak amplitude of the torque modulation. Each line corresponds to a specific DTM configuration, demonstrating how different settings can affect the battery temperature over time. For example, line 316 represents no DTM, line 317 represents DTM with an amplitude of torque modulation set at best efficiency, line 318 represents DTM with an amplitude of torque modulation set at best efficiency plus 5 Newton meters (Nm), line 319 represents DTM with an amplitude of torque modulation set at best efficiency plus 15 Newton meters (Nm), line 320 represents DTM with an amplitude of torque modulation set at best efficiency plus 25 Newton meters (Nm), line 321 represents DTM with an amplitude of torque modulation set at best efficiency plus 35 Newton meters (Nm), line 322 represents DTM with an amplitude of torque modulation set at best efficiency plus 45 Newton meters (Nm), line 323 represents DTM with an amplitude of torque modulation set at best efficiency plus 40 Newton meters (Nm), line 324 represents DTM with an amplitude of torque modulation set at best efficiency plus 25 Newton meters (Nm), and line 325 represents DTM with an amplitude of torque modulation set at best efficiency plus 10 Newton meters (Nm). Other amplitudes may be implemented in various embodiments.

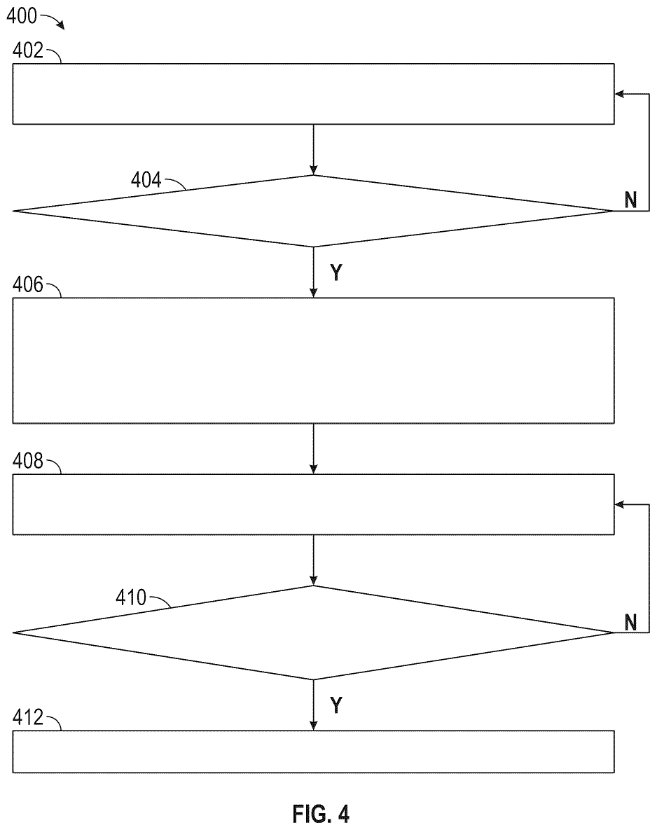

FIG. 4 illustrates a flow diagram of a method 400 for vehicle propulsion system warmup using dynamic torque modulation according to one or more embodiments. The method 400 can be implemented using any suitable system or device. For example, the method 400, and its steps, can be implemented using the computer system 42 of FIGS. 1 and 2. The method 400 is now described with reference to at least portions of FIGS. 1-3 but is not so limited.

The method 400 involves several steps to dynamically modulate an electric motor torque command for the electric motor 20 of the vehicle 100 to cause the propulsion system 16 and/or the battery system 22 of the vehicle 100 to increase in temperature.

At block 402, the dynamic torque modulation engine 212 detects the occurrence of a trigger event associated with the battery system 22 of the vehicle 100. The trigger event can be a user command, the temperature of the battery system 22 being below a temperature threshold, or another suitable trigger event. For example, if the user wants to charge an EV or PHEV at a charging station, the user can cause the battery system to heat up to a desired temperature using DTM prior to arriving at a destination charging station. As another example, if the temperature of the battery system 22 is below a temperature threshold (e.g., minus 7 degrees Celsius), DTM is triggered. The detection of the trigger event initiates the dynamic torque modulation process to warm up the battery system 22.

At decision block 404, the motor control engine 210 determines whether the trigger event is detected. If not, the method 400 returns to block 402. If the trigger event is detected at decision block 404, the method 400 proceeds to block 406. At block 406, responsive to detecting the occurrence of the trigger event, the dynamic torque modulation engine 212 dynamically modulates an electric motor torque command between a first torque value and a second torque value that is less than the first torque value. The electric motor torque command causes the electric motor 20 of the vehicle 100 to provide torque at a value defined by the electric motor torque command. This dynamic torque modulation increases heat generation for the battery system 22, thereby warming up the battery system 22 more quickly than existing motor control strategies.

At block 408, the dynamic torque modulation engine 212 monitors a temperature of the battery system 22 while dynamically modulating the electric motor torque command. The monitoring process ensures that the temperature of the battery system 22 is continuously tracked to determine the effectiveness of the dynamic torque modulation in warming up the battery system 22.

At decision block 410, the dynamic torque modulation engine 212 determines whether the temperature of the battery system 22 satisfies the temperature threshold. If not, the method 400 returns to block 408 and continues monitoring the temperature of the battery system 22. If the temperature of the battery system 22 satisfies the temperature threshold at decision block 410, the method 400 proceeds to block 412. At block 412, the motor control engine 210, responsive to determining that the temperature of the battery system 22 satisfies the temperature threshold, ceases dynamically modulating the electric motor torque command. This step ensures that the dynamic torque modulation is stopped once the battery system 22 reaches the desired temperature (e.g., the temperature threshold or another suitable temperature), preventing any unnecessary energy consumption or potential damage to the battery system 22.

According to one or more embodiments, the method 400 includes ceasing dynamically modulating the electric motor torque command responsive to determining that the electric motor is operating in a restricted zone. A “restricted zone” refers to a specific operational range or condition of the electric motor where DTM is not advisable or permissible due to potential risks or inefficiencies. These zones are predefined based on various factors, such as safety concerns; efficiency loss; noise, vibration, and harshness (NVH) issues; battery system health; regulatory compliance; and/or the like, including combinations and/or multiples thereof. This step ensures that the dynamic torque modulation is stopped if the electric motor enters a zone where continued modulation could cause damage or inefficiency.

According to one or more embodiments, the method 400 may include additional processes, such as randomly selecting a wave shape (e.g., triangular, square, sinusoidal, and/or the like, including combinations and/or multiples thereof) of the electric motor torque command, a frequency of the electric motor torque command, and a peak amplitude of the electric motor torque command. These selections can be optimized to maximize battery system heat generation and address NVH issues, ensuring a smooth and efficient operation of the propulsion system 16 of the vehicle 100.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the one or more processing devices 44 of FIG. 1 or 2, and/or the like) of a computing system (e.g., the computer system 42 of FIGS. 1 and 2 and/or the like), cause the processor to perform the processes described herein.

One or more embodiments offer significant technical benefits, by dynamically modulating the electric motor torque command between a first torque value and a second torque value. For example, one or more embodiments increases the heat generation within the battery system. This approach leverages the inherent inefficiencies in the battery's power delivery to produce additional heat, which is then used to warm up the battery system more quickly than existing motor control strategies. This rapid warmup is particularly beneficial in cold ambient conditions, where battery performance is typically degraded.

The dynamic modulation of the torque command ensures that the battery system can reach its optimal operating temperature faster, thereby improving the vehicle's overall performance and efficiency. This approach is advantageous over existing preconditioning strategies that rely on external power sources or resistive heating elements, which can be inefficient and time-consuming. Instead, one or more embodiments utilizes the vehicle's existing propulsion system to achieve the desired thermal management, making such an approach a more integrated and efficient solution.

Additionally, one or more embodiments includes monitoring the temperature of the battery system during the dynamic modulation process. This continuous monitoring allows for precise control over the battery's temperature, ensuring that the modulation ceases once the desired temperature threshold is reached, preventing the battery system from overheating. This not only prevents potential damage to the battery but also optimizes energy consumption by stopping the modulation when it is no longer needed.

Furthermore, the ability to dynamically modulate the torque command based on real-time temperature data provides a more responsive and adaptive thermal management strategy. This ensures that the battery system achieves an optimal temperature, regardless of varying ambient conditions or operational demands, thereby enhancing the reliability and longevity of the battery system and thus, of the vehicle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A computer-implemented method comprising:
detecting an occurrence of a trigger event associated with a battery system of a vehicle;
responsive to detecting the occurrence of the trigger event, dynamically modulating an electric motor torque command between a first torque value and a second torque value that is less than the first torque value, wherein the electric motor torque command causes an electric motor of the vehicle to provide torque at a value defined by the electric motor torque command, and wherein the first torque value is an amount of torque greater than a maximum efficiency torque value for the electric motor;
monitoring a temperature of the battery system while dynamically modulating the electric motor torque command; and
responsive to determining that the temperature of the battery system satisfies a temperature threshold, ceasing dynamically modulating the electric motor torque command.

2. The computer-implemented method of claim 1, wherein the trigger event is a user command.

3. The computer-implemented method of claim 1, wherein the trigger event is the temperature of the battery system being below the temperature threshold.

4. The computer-implemented method of claim 1, wherein the battery system is a rechargeable energy storage system (RESS).

5. The computer-implemented method of claim 1, wherein the vehicle is selected from a group consisting of an electric vehicle, a hybrid electric vehicle, and a plug-in hybrid electric vehicle.

6. The computer-implemented method of claim 1, wherein the first torque value and the second torque value are selected to maximize battery system heat generation.

7. (canceled)

8. The computer-implemented method of claim 1, further comprising randomly selecting a wave shape of the electric motor torque command, a frequency of the electric motor torque command, and a peak amplitude of the electric motor torque command.

9. The computer-implemented method of claim 1, further comprising ceasing dynamically modulating the electric motor torque command responsive to determining that the electric motor is operating in a restricted zone.

10. A vehicle comprising:
an electric motor;
a battery system electrically coupled to the electric motor; and
a processing system comprising:
a memory comprising computer-readable instructions; and
a processing device for executing the computer-readable instructions, the computer-readable instructions controlling the processing system to perform operations comprising:
detecting an occurrence of a trigger event associated with the battery system of the vehicle;
responsive to detecting the occurrence of the trigger event, dynamically modulating an electric motor torque command between a first torque value and a second torque value that is less than the first torque value, wherein the electric motor torque command causes the electric motor of the vehicle to provide torque at a value defined by the electric motor torque command, and wherein the first torque value is an amount of torque greater than a maximum efficiency torque value for the electric motor;
monitoring a temperature of the battery system while dynamically modulating the electric motor torque command; and
responsive to determining that the temperature of the battery system satisfies a temperature threshold, ceasing dynamically modulating the electric motor torque command.

11. The vehicle of claim 10, wherein the trigger event is a user command.

12. The vehicle of claim 10, wherein the trigger event is the temperature of the battery system being below the temperature threshold.

13. The vehicle of claim 10, wherein the battery system is a rechargeable energy storage system (RESS).

14. The vehicle of claim 10, wherein the vehicle is selected from a group consisting of an electric vehicle, a hybrid electric vehicle, and a plug-in hybrid electric vehicle.

15. The vehicle of claim 10, wherein the first torque value and the second torque value are selected to maximize battery system heat generation.

16. (canceled)

17. The vehicle of claim 10, wherein the operations further comprise randomly selecting a wave shape of the electric motor torque command, a frequency of the electric motor torque command, and a peak amplitude of the electric motor torque command.

18. The vehicle of claim 10, wherein the operations further comprise ceasing dynamically modulating the electric motor torque command responsive to determining that the electric motor is operating in a restricted zone.

19. A computer program product comprising:
a set of one or more non-transitory computer-readable storage media;
program instructions, collectively stored in the set of one or more storage media, for causing a processor set to perform computer operations comprising:
detecting an occurrence of a trigger event associated with a battery system of a vehicle;
responsive to detecting the occurrence of the trigger event, dynamically modulating an electric motor torque command between a first torque value and a second torque value that is less than the first torque value, wherein the electric motor torque command causes an electric motor of the vehicle to provide torque at a value defined by the electric motor torque command, and wherein the first torque value is an amount of torque greater than a maximum efficiency torque value for the electric motor;
monitoring a temperature of the battery system while dynamically modulating the electric motor torque command; and
responsive to determining that the temperature of the battery system satisfies a temperature threshold, ceasing dynamically modulating the electric motor torque command.

20. The computer program product of claim 19, wherein the trigger event is the temperature of the battery system being below the temperature threshold.

21. The computer program product of claim 19, wherein the trigger event is a user command.

22. The computer program product of claim 19, wherein the vehicle is selected from a group consisting of an electric vehicle, a hybrid electric vehicle, and a plug-in hybrid electric vehicle.
